(19) United States
(12) Patent Application Publication
(10) Pub. No.: US 2009/0100964 A1
(43) Pub. Date: Apr. 23, 2009

(54) Bearing Housing

(75) Inventor: Paul Skoglund, Lerberget (SE)

Correspondence Address: BUCHANAN, INGERSOLL & ROONEY PC, POST OFFICE BOX 1404, ALEXANDRIA, VA, 22313-1404, US

(73) Assignee: HOGANAS AB (PUBL), Hoganas (SE)

(21) Appl. No.: 12/085,944

(22) PCT Filed: Dec. 22, 2006
(86) PCT No.: PCT/SE2006/001485

§ 371 Date: Jul. 23, 2008

Related U.S. Application Data
(60) Provisional application No. 60/754,316, filed on Dec. 29, 2005.

(30) Foreign Application Priority Data
Dec. 29, 2005 (SE) 0502926-9

(51) Int. Cl. F16C 7/00; B22F 3/12; B22F 3/24

(52) U.S. Cl. 74/579 R; 419/38; 419/28

(57) ABSTRACT

A bearing housing (1) comprising a first element (2) and a second element (3) is provided. The first and second element (2, 3) are connectable to each other, and adapted to abut each other in an interface (4) between the first and second element (2, 3). At least one cylindrical hole (5) is arranged in said interface (4) with its envelope surface (6) partly formed by the first element (2) and partly formed by the second element (3), wherein the hole (5) has at least one opening (7) on a first surface (8) formed by the first and second element (2, 3). The bearing housing (1) is further characterized in that at least one groove (11 a) is formed in the first surface (8) of the first element (2) and at least one groove (11b) is formed in the first surface (8) of the second element (3), wherein the grooves (11a, 11b) coincide to receive at least one rod-shaped fastening means for connection of the first and second element (2, 3).

### FIELD OF THE INVENTION

The present invention relates to a bearing housing comprising a first element and a second element. The first and second element are connectable to each other, and adapted to abut each other in an interface between the first and second element. At least one cylindrical hole is arranged in said interface with its envelope surface partly formed by the first element and partly formed by the second element, wherein the hole has at least one opening on a first surface formed by the first and second element. The present invention is especially useful for connecting rods made of compacted metal powders. The invention further relates to a method of manufacturing such a bearing housing.

### BACKGROUND OF THE INVENTION

A conventional bearing housing comprises two elements together forming a cylindrical hole in the interface between the two elements. In mounting the two elements are separated, a bearing is positioned in the cylindrical hole and the elements are fastened to each other, thereby retaining said bearing in said hole of the bearing housing. Manufacturing of bearing housings and especially connecting rods involves the steps of providing a cast or wrought material, heating the material and subjecting it to a forging operation. An improved production route of e.g. a connecting rod is to manufacture one piece and then divide them into two elements, e.g. by sawing. The elements are provided with holes and threads to use screws to reassemble the separated elements after mounting.

The dividing operation may also be splitting the blank in two elements. This splitting operation is in most of the cases performed by arranging notches or similar where a dividing line is preferred. In U.S. Pat. No. 4,569,109 such a bearing housing is disclosed. The splitted parts are then provided with drilled holes and threads to make it possible to reassemble them by e.g. screws.

Documents U.S. Pat. No. 5,460,776 and WO 98/16339 discloses methods of producing powder metallurgy connected articles by pressing, pre-sintering, separating the preform into two elements by splitting, and sintering the splitted elements. After sintering the elements are drilled and threaded.

In patent documents U.S. Pat. No. 4,923,674, U.S. Pat. No. 4,936,163 and U.S. Pat. No. 5,613,182 connecting rods are disclosed. A blank is manufactured by moulding a preform from powder metal and forging the preform after a heating step (powder forging). A fracture split separation is then performed followed by drilling and threading. For powder forging large presses are necessary to achieve high forces to be able to densify the preform.

Although the above mentioned publications mention improved ways of manufacturing bearing housings such as connecting rods, it is still complicated to manufacture such components. The manufacturing of bearing housings and connecting rods involve several manufacturing steps. It may also be noted that drilling and other machining is often difficult to accomplish in powder metallurgical components since they are usually formed of hard materials causing tool wear.

JP 59-121221 discloses a connecting rod made of a composite material with reinforced fibres. A circumferential U-groove and a U-bolt is arranged in the connecting rod. The purpose of the U-groove and the U-bolt is to avoid cutting off reinforcing fibres and thereby destroying the strength of the connecting rod.

There is a need for an improved design of bearing housings, such as connecting rods, parted sliding bearings, bearing cages etc. There is also a need for a method for facilitating the manufacturing thereof.

### SUMMARY OF THE INVENTION

An object of the invention is to provide a bearing housing, such as a connecting rod, which is easy to manufacture.

The above object is achieved in accordance with the present invention with a bearing housing comprising a first element and a second element. The first and second element are connectable to each other, and adapted to abut each other in an interface between the first and second element. At least one essentially cylindrical hole is arranged in said interface with its envelope surface partly formed by the first element and partly formed by the second element, wherein the hole has at least one opening or mouth on a first surface formed by the first and second element. The bearing housing is further characterised in that at least one groove is formed in said first surface of the first element and at least one groove is formed in said first surface of the second element, wherein said grooves coincide to receive at least one rod-shaped fastening means for connection of the first and second element.

This bearing housing is easy to manufacture by the powder metallurgical manufacturing route. The grooves are open in the compaction direction and are therefore possible to form during the powder compaction of the bearing housing. Thereby there is no need for any drilling and threading of holes for clamping the elements together. At least one rod-shaped fastening means is insertable in the coinciding grooves and may be tightened to secure the elements to each other.

The bearing housing will also result in an easier assembly of e.g. a bearing, a crankshaft etc since the grooves are open in the compaction direction, the rod-shaped fastening means may thereby in a fast way be put in two coinciding grooves and may be tightened in many ways. Rod-shaped fastening means may be e.g. a screw with threads and on which threaded nuts are arranged to be able to fasten the first and second element. The rod-shaped fastening means may also be a rod having heads in each end, which rod may be stretched, put in the coinciding grooves and allowed to contract. The heads may be manufactured to the rod in one piece.

At least two grooves coincide, i.e. at least one groove in the first element and at least one groove in the second element are coinciding to be able to receive one rod-shaped fastening means.

The bearing housing may receive a through-going shaft such as a crankshaft, but it may also have one opening only in one direction to support a bearing on one end of a shaft.

Preferred embodiments follow from the dependent claims.

Two grooves on the first element may be arranged opposite each other in relation to said hole and two grooves on the second element may be arranged opposite each other in relation to said hole, wherein one groove on the first element coincide with one groove on the second element and the other groove on the first element coincide with the other groove on the second element, thereby forming two grooves for receiving two rod-shaped fastening means. By this arrangement the elements are well secured, since a fastening force will be exerted on the opposite sides of the hole.

The first pair of grooves may be formed in said first surface and said second pair of grooves may be formed in a second surface. A benefit of this arrangement is that the load from the fastening means is balanced, not only in relation to the opening on a surface of the bearing housing but also in relation to the elements of the bearing housing.

The bearing housing may have a hole which has a second opening formed on a second surface. Thereby the bearing housing may receive a through-going shaft such as a crankshaft.

In one embodiment of the bearing housing a first half of the cylindrical hole is in the first element and a second half of the hole is in the second element. This facilitate mounting and allows e.g. for circumferential grooves or shoulders in the hole or insertion of e.g. a crankshaft.

The bearing housing may be a connecting rod. The inventive bearing housing is suitable for connecting rods, because an easy way of manufacturing is necessary to obtain an efficient production. Connecting rods for the automotive industry is a high volume product and there is a great concern to find improved solutions. The invention is especially applicable for the big end of a connecting rod.

A method for producing a bearing housing of the above kind is also disclosed. The method comprises providing a metal powder, compacting the metal powder to introduce at least one groove which are open in the compaction direction and sintering the compact. The compaction direction is perpendicular to the first surface of the bearing housing. Since, the grooves are open in the compaction direction it is possible already in the powder compaction to form the grooves for receiving the fastening means. There is no need of post treatments such as drilling and threading.

After heating the powder compact may be subjected to an optional forging step. By this an article having full density and high strength is achieved.

Another way of producing a powder metallurgical component is to compact the powder followed by sintering of the powder compact. An advantage of this production route is that a net shape component may be achieved from a few production steps.

To achieve an even more efficient production of a powder metallurgical component a fracture split operation is performed to form at least two elements. The advantages of making a fracture split is that the method will render in mating parts with high accuracy. Another advantage is that a high production rate may be obtained.

### SHORT DESCRIPTION OF THE DRAWINGS

The invention will in the following be described by way of example with reference to the appended schematic drawings which show presently preferred embodiments.

FIG. 1 illustrates in two views a conventional bearing housing in form of a connecting rod.

FIG. 2 illustrates in two views one embodiment of a connecting rod according to the present invention.

FIG. 3 illustrates in two views another embodiment of a connecting rod according to the present invention.

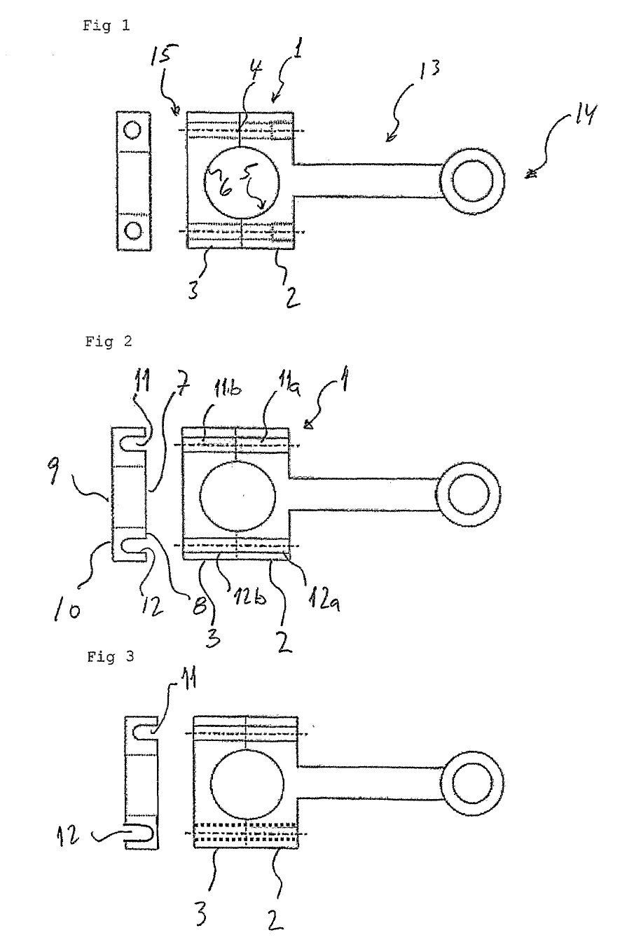

### DESCRIPTION OF PREFERRED EMBODIMENTS

In preferred embodiments the bearing housing 1 is in the form of a connecting rod 13 (see FIGS. 2 and 3). The connecting rod 13 has two ends, a smaller end 14 for the piston and a larger end 15 for the crankshaft. The larger end 15 comprises two elements 2, 3 which in a conventional connecting rod, are assembled and secured by e.g. screws and nuts. The connecting rod 13 has an interface 4 between the first and second element 2, 3. The interface may be embodied in many ways to ensure that the element 2, 3 are matching perfectly. In the interface 4 between the first and second element 2, 3 a cylindrical hole 5 having an inner envelope surface 6, is arranged. The envelope surface 6 may be the bearing surface between the connecting rod and the crankshaft. The cylindrical hole 5 has two openings 7, 9 on two surfaces 8, 10. A normal to the first and second surface is essentially parallell to an axial direction if the cylindrical hole. The connecting rod 13 further comprises two grooves 11a, 11b, 12a, 12b in each of the two elements 2, 3. One groove 11a from the first element 2 and one groove 11b from the second element 3 are coinciding to form a groove 11 adapted to receive a rod-shaped fastening means, e.g. screws, nuts and rivets. Similarly, one groove 12a from the first element 2 and one groove 12b from the second element 3 are coinciding to form a groove 12 adapted to receive a rod-shaped fastening means. Two pairs of coinciding grooves 11, 12 are thus formed in this embodiment and may both be arranged on the first surface 8 according to FIG. 2 or on the first and second surface 8, 10 according to FIG. 3.

A metal powder is compacted to form a connecting rod. Examples of powder materials which may be suitable for use in connection to the present invention are commonly used iron-powder mixtures containing 2% of copper, 0.8% of graphite, another alternative is to use pre-alloyed powder such as Distaloy HP and Astaloy CrL containing 1.5% chromium and 0.2% molybdenum, all available from Höganäs AB, Sweden.

The process for manufacturing connecting rods may be powder forging or a press and sintering process.

A normal production route for powder forging is to produce a preform of metal powder and heat to between 980° C. and 1090° C. The heated preform is then forged with a pressure of 760 to 970 MPa to a density above 7.8 g/cm³. The forging die may be preheated to a temperature between 370 and 540° C.

The compaction pressure in a press and sintering process may be between 600 and 1000 MPa. The sintering temperature may be between 1080° C. and 1300° C. in atmospheres of ordinary endogas or various hydrogen/nitrogen mixtures.

Other modifications are possible within the scope of the invention, which is defined in the claims.

For example a bearing housing may comprise more than two elements, depending on the complexity of a bearing assembly.

The bearing housing may be surface densified to improve the dynamic properties.

1. A bearing housing (1) comprising a first element (2) and a second element (3), the first and second element (2, 3) being connectable to each other, and adapted to abut each other in an interface (4) between the first and second element (2, 3), the bearing housing (1) further comprises at least one essentially cylindrical hole (5) arranged in said interface (4) with its envelope surface (6) partly formed by the first element (2) and partly formed by the second element (3), wherein the hole (5) has at least one opening (7) on a first surface (8) formed by the first and second element (2, 3), wherein at least one groove (11a) is formed in said first surface (8) of the first element (2) and at least one groove (11b) is formed in said first surface (8) of the second element (3), wherein said grooves (11a, 11b) coincide to be adapted to receive at least one rod-shaped fastening means for connection of the first and second element (2, 3).

2. The bearing housing (1) according to claim 1, wherein two grooves (11a, 12a) on the first element (2) are arranged opposite each other in relation to said hole and two grooves (11a, 12b) on the second element (3) are arranged opposite each other in relation to said hole (5), wherein one groove (11a) on the first element (2) coincide with one groove (11b) on the second element (3) and the other groove (12a) on the first element (2) coincide with the other groove (12b) on the second element (3), thereby forming two grooves (11, 12) for receiving two rod-shaped fastening means.

3. The bearing housing (1) according to claim 1, wherein the first pair of grooves (11) are formed in said first surface (8) and said second pair of grooves (12) are formed in a second surface (10).

4. The bearing housing (1) according to claim 1, wherein the hole (5) has a second opening (9) formed on said second surface (10).

5. The bearing housing (1) according to claim 1, wherein a first half of the hole (5) is in the first element (2) and a second half of the hole (5) is in the second element (3).

6. The bearing housing (1) according to claim 1, wherein the bearing housing (1) is a connecting rod (13).

7. A method for producing a bearing housing according to claim 1 comprising:
providing a metal powder,
compacting the metal powder to form a compact
heating the compact.

8. The method according to claim 7, wherein the heating is followed by a forging step.

9. The method according to claim 7, wherein the heating is made to sinter the powder compact.

10. The method according to anyone of claims claim 7, wherein a fracture split operation is performed to form at least two elements.

11. The bearing housing (1) according to claim 2, wherein the first pair of grooves (11) are formed in said first surface (8) and said second pair of grooves (12) are formed in a second surface (10).

12. The bearing housing (1) according to claim 2, wherein the hole (5) has a second opening (9) formed on said second surface (10).

13. The bearing housing (1) according to claim 3, wherein the hole (5) has a second opening (9) formed on said second surface (10).

14. The bearing housing (1) according to claim 11, wherein the hole (5) has a second opening (9) formed on said second surface (10).

15. The bearing housing (1) according to claim 2, wherein a first half of the hole (5) is in the first element (2) and a second half of the hole (5) is in the second element (3).

16. The bearing housing (1) according to claim 2, wherein the bearing housing (1) is a connecting rod (13).

17. A method for producing a bearing housing according to claim 2, comprising:
providing a metal powder,
compacting the metal powder to form a compact
heating the compact.

18. The method according to claim 8, wherein the heating is made to sinter the powder compact.

19. The method according to claim 8, wherein a fracture split operation is performed to form at least two elements.

20. The method according to claim 9, wherein a fracture split operation is performed to form at least two elements.
